(19) United States
(12) Patent Application Publication
(10) Pub. No.: US 2020/0116662 A1
(43) Pub. Date: Apr. 16, 2020

(54) SYSTEM FOR ANALYZING FUEL COMPONENTS USING AN RF SENSOR DEVICE FOR A VEHICLE

(71) Applicants: Hyundai Motor Company, Seoul (KR); Kia Motors Corporation, Seoul (KR); Jeju National University Industry-Academic Cooperation Foundation, Jeju-si (KR)

(72) Inventors: Jin Ha LEE, Seoul (KR); Jun Sung Park, Yongin-si (KR); Seokjae Kim, Seongnam-si (KR); Chong Hyun Lee, Jeju-si (KR); Yun Sang Jeong, Seoul (KR); Jeehyun Lee, Seoul (KR)

(73) Assignees: Hyundai Motor Company, Seoul (KR); Kia Motors Corporation, Seoul (KR); Jeju National University Industry-Academic Cooperation Foundation, Jeju-si (KR)

(21) Appl. No.: 16/206,422

(22) Filed: Nov. 30, 2018

(30) Foreign Application Priority Data
Oct. 16, 2018 (KR) 10-2018-0123135

(51) Int. Cl. G01N 27/22; G01F 23/26; G01F 23/28

(52) U.S. Cl. CPC G01N 27/221; G01F 23/28; G01F 23/266

(57) ABSTRACT

A system for analyzing fuel component may include an RF sensor including first and second patch sensors, and a function generator for connecting the first patch sensor and the second patch sensor through a ground patch and function converting the electrical signals of the fuel contained in the fuel tank detected by the first patch sensor and the second patch sensor, a resonance frequency measuring unit converting the signal obtained from the function generator into a resonance frequency, a resonance frequency comparing unit for comparing the obtained resonance frequency with a resonance frequency inherent to the fuel, and a determination unit for determining the state of the fuel contained in the fuel tank according to the comparison result of the obtained resonance frequency and the resonance frequency inherent to the fuel.

### CROSS-REFERENCE TO RELATED APPLICATION

The present application claims priority to Korean Patent Application No. 10-2018-0123135 filed on Oct. 16, 2018, the entire contents of which is incorporated herein for all purposes by this reference. The entire contents of which are incorporated herein by reference.

### BACKGROUND OF THE INVENTION

### Field of the Invention

The present invention relates to a system for analyzing fuel component using a Radio Frequency (RF) sensor device for a vehicle. More particularly, the present invention relates to a system for analyzing fuel component using a Radio Frequency (RF) sensor device for a vehicle to detect a specific resonance frequency according to the inherent dielectric constant of the fuel.

### Description of Related Art

As an RF signal passes through the material between the two antennae, there is a specific resonance frequency that minimizes the reflection coefficient (dB) according to the inherent dielectric constant of the material. All objects have inherent dielectric constants. Gasoline, diesel, kerosene, heavy oil and other vehicle fuels also have inherent dielectric constants. Therefore, when the fuel is placed between the RF sensors, the RF sensor has its own resonance frequency depending on the dielectric constant of the fuel.

Further, when the air and the specific fuel are in the RF sensor, the overall dielectric constant changes depending on the air amount. Therefore, depending on the air amount, the RF sensor has its own resonance frequency.

On the other hand, there are various methods for discriminating the kind and harmfulness of the fuel. Conventionally, there is a method in which additives are added to a fuel to investigate the components of the fuel using a chemical reaction, the type of the fuel is determined by use of an inverted scattering signal of ultrasonic waves, or a method in which the sensor is directly contacted with the fuel.

When chemical reactions are used, it is very complicated and costly to add a chemical sample to check the condition of the fuel. When an inverse scattering signal is used, since there is an indirect method, a fuel having the same reverse scattering power cannot be distinguished from its original limit.

Therefore, these methods cannot be applied to actual vehicles due to problems in cost, difficulty in analyzing the size of equipment, and time required to install fuel in the vehicle.

The information included in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a system for analyzing fuel component using an RF sensor device for a vehicle which detects the inherent resonance frequency in a response to the inherent dielectric constant of the fuel for discriminating the type of the fuel or the substance in the fuel.

A system for analyzing fuel component according to an exemplary embodiment of the present invention may include an RF sensor device including a first patch sensor attached to an outside of a fuel tank, a second patch sensor attached to the outside of the fuel tank to face the first patch sensor, and a function generator for connecting the first patch sensor and the second patch sensor through a ground patch and function converting the electrical signals of the fuel contained in the fuel tank detected by the first patch sensor and the second patch sensor, a resonance frequency measuring unit converting the signal obtained from the function generator into a resonance frequency, a resonance frequency comparing unit for comparing the obtained resonance frequency with a resonance frequency inherent to the fuel, and a determination unit for determining the state of the fuel contained in the fuel tank according to the comparison result of the obtained resonance frequency and the resonance frequency inherent to the fuel.

The determination unit can discriminate the type of the fuel by use of the resonance frequency data inherent to the fuel.

The determination unit can discriminate the quality of the fuel by comparing the resonance frequency of the fuel with the resonance frequency of the fuel.

The determination unit can discriminate the sulfur content of the fuel by use of the resonance frequency inherent to the fuel and the sulfur content data.

The determination unit can discriminate whether impurities, water, or the like is infiltrated into the fuel tank using the resonance frequency data inherent to the fuel.

According to an exemplary embodiment of the present invention, the resonance frequency of the fuel is used to identify the kind of the fuel or the substance in the fuel and precisely distinguish the sulfur content of the diesel so that the post-treatment catalyst of the diesel engine vehicle is poisoned by the sulfur component contained in the diesel, the cycle may be accurately judged, and the desulfurization cycle may be accurately determined.

Accordingly, the desulfurization combustion control of the engine may be optimized and the performance of the catalyst may be maintained.

Furthermore, it is possible to distinguish between general gasoline of gasoline engine vehicle and hi drivability gasoline to optimize engine combustion according to the corresponding fuel.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram showing a system for analyzing fuel component according to an exemplary embodiment of the present invention.

FIG. 2 is a diagram illustrating a design example of an RF sensor device configured for a vehicle according to an exemplary embodiment of the present invention.

FIG. 3 is a graph showing a change in resonance frequency measured by a patch type RF sensor according to an exemplary embodiment of the present invention, with respect to the mixing ratios of general commercial diesel and ship oil (inherent sulfur).

FIG. 4 is a graph showing a resonance frequency and an average resonance frequency measured several times by an RF sensor device according to an exemplary embodiment of the present invention, for each mixing ratio of a common commercial diesel and a marine oil (inherent sulfur).

FIG. 5 is a graph showing changes in resonance frequency measured by an RF sensor device according to an exemplary embodiment of the present invention, according to oil refiner of a general commercial diesel.

FIG. 6 is a graph showing the resonance frequency and the average resonance frequency measured several times by an RF sensor device according to an exemplary embodiment of the present invention, by refiners of the general commercial diesel.

FIG. 7 is a graph showing the resonance frequency and the average resonance frequency measured several times by an RF sensor device according to an exemplary embodiment of the present invention, by refiners of the general commercial diesel.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Hereinafter, various Exemplary embodiments of the present application will be described more fully with reference to the accompanying drawings, in which exemplary embodiments of the present invention are shown as those skilled in the art would realize. The described embodiments may be modified in various different ways, all without departing from the spirit or scope of the present invention.

Furthermore, in exemplary embodiments of the present invention, since like reference numerals designate like elements having the same configuration, various exemplary embodiments are representatively described, and in other exemplary embodiments of the present invention, only configurations different from the various exemplary embodiments will be described.

The drawings are schematic, and are not illustrated in accordance with a scale. Relative dimensions and ratios of portions in the drawings are illustrated to be exaggerated or reduced in size for clarity and convenience, and the dimensions are just exemplified and are not limiting. Furthermore, same structures, elements, or components illustrated in two or more drawings use same reference numerals for showing similar features. It will be understood that when an element such as a layer, film, region, or substrate is referred to as being “on” another element, it may be directly on the other element or intervening elements may also be present.

The exemplary embodiment of the present invention shows an exemplary embodiment of the present invention in detail. As a result, various modifications of the drawings will be expected. Therefore, the exemplary embodiment of the present invention is not limited to a specific aspect of the illustrated region, and for example, includes modifications of an aspect by manufacturing.

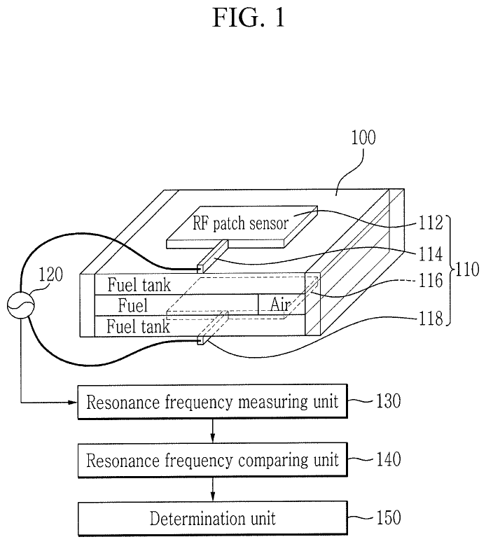

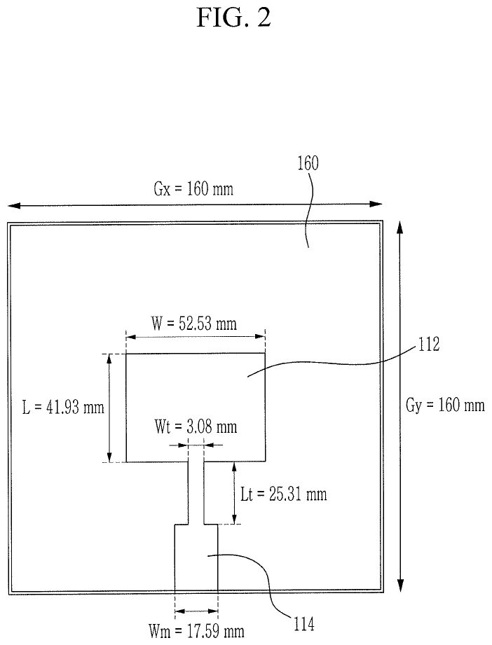

Now, a system for analyzing fuel component according to an exemplary embodiment of the present invention will be described with reference to FIGS. 1 and 2.

FIG. 1 is a schematic diagram showing a system for analyzing fuel component according to an exemplary embodiment of the present invention, and FIG. 2 is a diagram illustrating a design example of an RF sensor device configured for a vehicle according to an exemplary embodiment of the present invention.

Referring to FIG. 1, a system for analyzing fuel component according to an exemplary embodiment of the present invention includes an RF sensor device including a first patch sensor 112, a second patch sensor 116, and a function generator 120, a resonance frequency measuring unit 130, a resonance frequency comparing unit 140, and a determination unit 150.

The first patch sensor 112 may be attached to an outside of a fuel tank 100, and the second patch sensor 116 may be attached to the outside of the fuel tank 100 to face the first patch sensor 112.

The first patch sensor 112 and the second patch sensor 116 may be connected to the function generator 120 through ground patches 114 and 118. The function generator 120 may function convert the electrical signals of the fuel contained in the fuel tank detected by the first patch sensor 112 and the second patch sensor 116.

The RF sensor 110 according to an exemplary embodiment of the present invention may be a patch type RF sensor including the first patch sensor 112, the second patch sensor 116, and the ground patches 114 and 118.

The resonance frequency measuring unit 130 converts the signal obtained from the function generator 120 into a resonance frequency. Fuel and air may be present in the internal of the fuel tank. When the fuel and the air are mixed in the fuel tank, the total dielectric constant changes depending on the air amount. Therefore, even if the same fuel is used, the resonance frequency measuring unit 130 measures the resonance frequency differently according to the air amount in the fuel tank.

The resonance frequency comparing unit 140 compares the obtained resonance frequency with a resonance frequency inherent to the fuel. The inherent resonance frequency of the fuel is a predetermined value according to the inherent dielectric constant of the fuel. For example, in the case of light oil, the resonance frequency at the point where the reflection coefficient is minimum is preset according to the sulfur content, depending on whether the gasoline fuel is gasoline general fuel or extreme high-running gasoline fuel. Furthermore, it is confirmed that the light oil for each oil refiner has different resonance frequencies.

The determination unit 15 determines the state of the fuel contained in the fuel tank 100 according to the comparison result of the obtained resonance frequency and the resonance frequency inherent to the fuel.

The determination unit 150 may discriminate the type of the fuel by use of the resonance frequency data inherent to the fuel.

Furthermore, the determination unit 150 may discriminate the quality of the fuel by comparing the resonance frequency of the fuel with a resonance frequency inherent to the fuel.

Furthermore, the determination unit 150 may discriminate the sulfur content of the fuel by use of the resonance frequency inherent to the fuel and the sulfur content data.

Furthermore, the determination unit 150 may discriminate whether impurities, water, or the like is infiltrated into the fuel tank using the resonance frequency data inherent to the fuel.

Meanwhile, as shown in FIG. 2, the RF sensor 110 may be attached to the acrylic plate 160 and the acrylic plate 160 may be attached to the outside of the fuel tank. For example, the acrylic plate 160 may have a width Gx of about 160 mm and a length Gy of about 160 mm, and the first patch sensor 112 and the second patch sensor 116 may be set to have a lateral width W of about 52.53 mm and a vertical width L of about 41.93 mm, and the ground patches 114 and 118 may be set to the shape, length, and width shown in FIG. 2.

Meanwhile, the RF sensor according to various exemplary embodiments of the present invention may be a monopole type sensor including a plate patch attached to one side of the fuel tank, and a probe connected to the plate patch and penetrating into the fuel tank and being infiltrated with fuel.

The system for analyzing fuel component according to an exemplary embodiment of the present invention may be used to measure the resonance frequency of fuel by mounting the patch type RF sensor and the monopole type RF sensor shown in FIG. 1, respectively, or simultaneously outside the fuel tank.

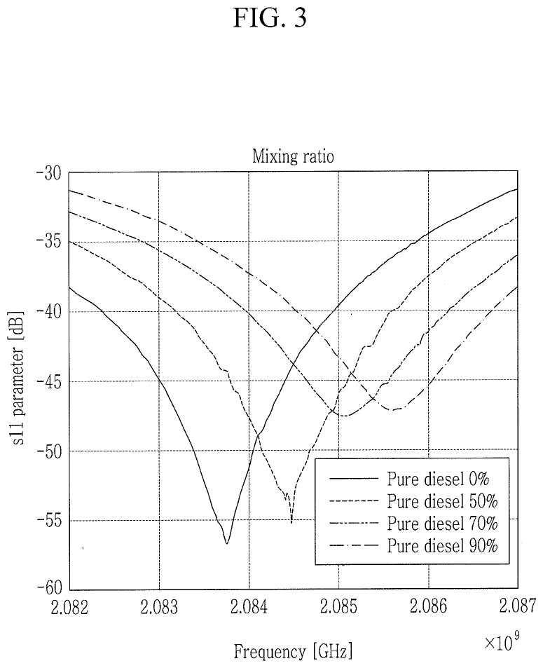

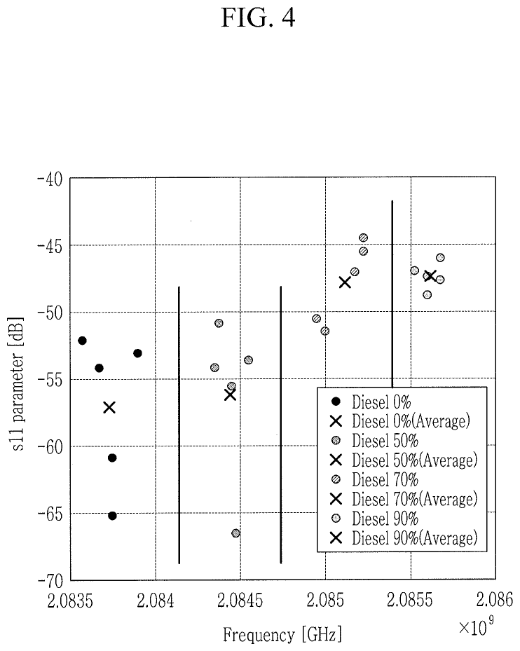

FIG. 3 is a graph showing a change in resonance frequency measured by a patch type RF sensor according to an exemplary embodiment of the present invention, with respect to the mixing ratios of general commercial diesel and ship oil (inherent sulfur), and FIG. 4 is a graph showing a resonance frequency and an average resonance frequency measured several times by an RF sensor device according to an exemplary embodiment of the present invention, for each mixing ratio of a common commercial diesel and a marine oil (inherent sulfur).

As shown in FIG. 3, when the pure diesel is 0%, the specific resonance frequency at which the reflection coefficient (s11 parameter) becomes minimum is about 2.08375 GHz, where the minimum reflection coefficient is about −56.75 dB. When the pure diesel is 50%, the specific resonance frequency is about 2.08447 GHz, where the minimum reflection coefficient is about −55.29 dB. When the pure diesel is 70%, the specific resonance frequency is about 2.08504 GHz, where the minimum reflection coefficient is about −47.58 dB. Furthermore, when the pure diesel is 90%, the specific resonance frequency is about 2.08560 GHz, where the minimum reflection coefficient is about −47.21 dB. As described above, it may be confirmed that the resonance frequency at which the reflection coefficient becomes minimum varies depending on the sulfur content in the diesel.

As shown in FIG. 4, it is possible to derive the average resonance frequency at the minimum reflection coefficient by measuring the resonance frequency several times according to the mixing ratio of diesel and ship oil (inherent sulfur) by experiment.

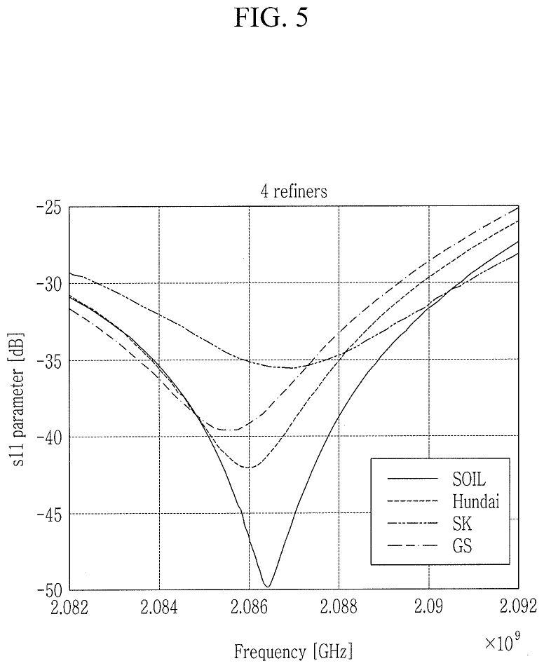

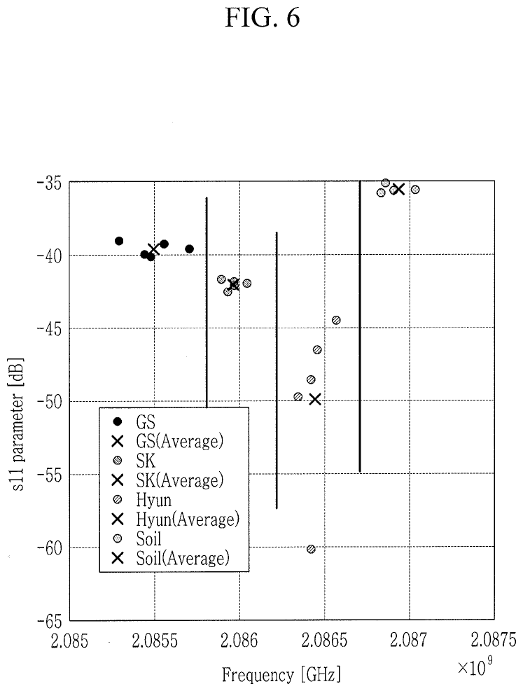

FIG. 5 is a graph showing changes in resonance frequency measured by an RF sensor according to an exemplary embodiment of the present invention, according to oil refiner of a general commercial diesel, and FIG. 6 is a graph showing the resonance frequency and the average resonance frequency measured several times by an RF sensor device according to an exemplary embodiment of the present invention, by refiners of the general commercial diesel.

FIG. 5 and FIG. 6 show changes in the resonance frequency of refineries of general commercial diesel. In the case of GS company, the specific resonance frequency of diesel having the minimum reflection coefficient is about 2.08556 GHz, where the minimum reflection coefficient is about −39.59 dB. In the case of Hyundai company, the resonant frequency of diesel is about 2.08597 GHz, and the minimum reflection coefficient is about −42.03 dB. In the case of Soil company, the resonant frequency of diesel is about 2.08642 GHz, and the minimum reflection coefficient is about −49.85 dB. Furthermore, in the case of SK company, the resonant frequency of diesel is about 2.08642 GHz, and the minimum reflection coefficient is about −35.52 dB. Like this, it may be seen that the resonance frequency of the diesel with the minimum reflection coefficient for each refiner is different, and the sulfur content contained in diesel is different.

As shown in FIG. 6, the resonance frequency of the oil refiner and the diesel may be measured several times by experiments to derive the average resonance frequency of the diesel at the minimum reflection coefficient.

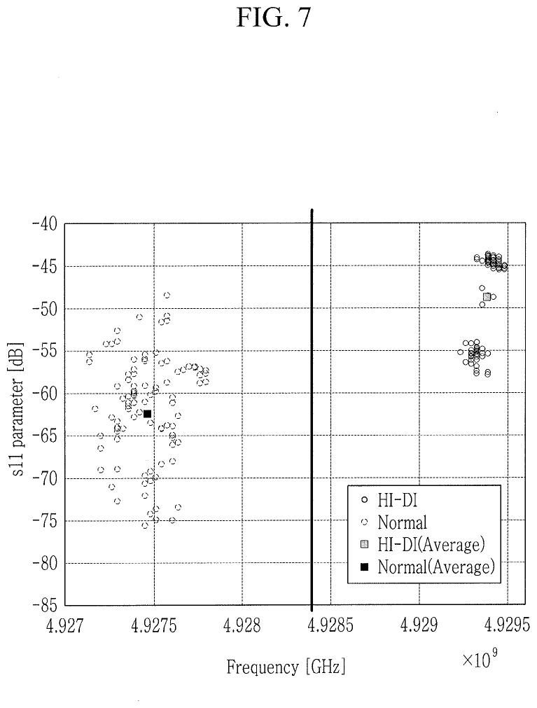

FIG. 7 is a graph showing the resonance frequency and the average resonance frequency measured several times by an RF sensor device according to an exemplary embodiment of the present invention, by refiners of the general commercial diesel.

As shown in FIG. 7, the average resonance frequency of the gasoline general fuel with the minimum reflection coefficient is about 4.927 GHz and the average resonance frequency of the extreme high mileage gasoline fuel is about 4.929 GHz. and the resonance frequency difference between gasoline general fuel and extreme high mileage gasoline fuel is about 1.915 MHz. As described above, even in the case of gasoline fuel, the resonance frequency is different according to the difference of the dielectric constant, and the combustion may be optimized and operated according to the gasoline fuel type discriminated by the resonance frequency.

Like this, according to an exemplary embodiment of the present invention, the resonance frequency of the fuel is used to identify the kind of the fuel or the substance in the fuel and precisely distinguish the sulfur content of the diesel so that the post-treatment catalyst of the diesel engine vehicle is poisoned by the sulfur component contained in the diesel, the cycle may be accurately judged, and the desulfurization cycle may be accurately determined.

Accordingly, the desulfurization combustion control of the engine may be optimized and the performance of the catalyst may be maintained.

Furthermore, it is possible to distinguish between general gasoline of gasoline engine vehicle and hi drivability gasoline to optimize engine combustion according to the corresponding fuel.

For convenience in explanation and accurate definition in the appended claims, the terms “upper”, “lower”, “inner”, “outer”, “up”, “down”, “upper”, “lower”, “upwards”, “downwards”, “front”, “rear”, “back”, “inside”, “outside”, “inwardly”, “outwardly”, “internal”, “external”, “inner”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A system for analyzing component of fuel, the system comprising:
a radio frequency (RF) sensor device including:
a first patch sensor attached to a first portion of a fuel tank and generating a first electrical signal related to the fuel contained in the fuel tank;
a second patch sensor attached to a second portion of the fuel tank to face the first patch sensor and generating a second electrical signal related to the fuel contained in the fuel tank; and
a function generator connected to the first patch sensor and the second patch sensor through a ground patch and configured for converting the first and second electrical signals related to the fuel contained in the fuel tank detected by the first patch sensor and the second patch sensor into a third electrical signal;
a resonance frequency measuring unit connected to the function generator and configured converting the third electrical signal obtained from the function generator into a resonance frequency;
a resonance frequency comparing unit connected to the resonance frequency measuring unit and configured for comparing the resonance frequency with an inherent resonance frequency which is inherent to the fuel and for generating a comparison result thereof; and
a determination unit connected to the resonance frequency comparing unit and configured for determining a state of the fuel contained in the fuel tank according to the comparison result of the resonance frequency and the inherent resonance frequency which is inherent to the fuel.

2. The system for analyzing the component of the fuel of claim 1,
wherein the determination unit discriminates a type of the fuel by use of data of the inherent resonance frequency which is inherent to the fuel.

3. The system for analyzing the component of the fuel of claim 1,
wherein the determination unit discriminates a quality of the fuel by comparing the resonance frequency of the fuel with the inherent resonance frequency which is inherent to the fuel.

4. The system for analyzing the component of the fuel of claim 1,
wherein the determination unit discriminates a sulfur content of the fuel by use of the inherent resonance frequency which is inherent to the fuel and data of the sulfur content.

5. The system for analyzing the component of the fuel of claim 1,
wherein the determination unit discriminates whether at least an impurity or water is infiltrated into the fuel tank using the inherent resonance frequency which is inherent to the fuel.

6. The system for analyzing the component of the fuel of claim 1, wherein the inherent resonance frequency of the fuel is a value predetermined according to inherent dielectric constant of the fuel.
